(19) United States
(12) Patent Application Publication
(10) Pub. No.: US 2005/0088277 A1
(43) Pub. Date: Apr. 28, 2005

(54) System consisting of a household appliance and an external apparatus

(76) Inventors: Joerg Boeger, Rheda-Wiedenbrueck (DE); Torsten Erdmann, Beckum (DE); Thomas Koester, Bielefeld (DE); Detlef Niehaus, Hamm (DE); Herbert Krauthausen, Waldbuttelbrunn (DE)

Correspondence Address: Law Offices of Karl Hormann, P.O. Box 381516, Cambridge, MA, 02238-1516, US

(21) Appl. No.: 10/972,945

(22) Filed: Oct. 25, 2004

(30) Foreign Application Priority Data
Oct. 24, 2003 (DE) DE103 49 978.4-42

(51) Int. Cl. G05B 23/02

(52) U.S. Cl. 340/3.43; 340/10.1; 714/30

(57) ABSTRACT

A system for connecting a household appliance to an external apparatus for the purpose of parameterizing, error diagnosing and remotely maintaining the former by an exchange of electromagnetic radiation signals consisting, on the one hand, of separated sequences of first search codes made up of a plurality of code words differing from each other transmitted to receive an answer signal consisting of a single code word and generated in response to a predetermined number of transmitted first search codes being in conformity with second search codes stored at the device receiving at least a predetermined number of sequences of the first search code.

### BACKGROUND OF THE INVENTION

1. Field of the Invention

The invention, in general, relates to a system consisting of a household appliance and an external apparatus for the parameterization, error or failure diagnosis and remote maintenance of the household appliance and, more particularly, to a system in which one of the appliance and the apparatus is provided with a transmitter and the other of the appliance and apparatus is provided with a receiver designed for an exchange of electromagnetic radiation in the wavelength range of visible light or infra red and which are actuated by actuation of an actuator at the corresponding appliance or apparatus and wherein actuation of the transmitter causes it continuously to transmit search codes consisting of a plurality of code words which differ from each other and which were previously set and stored in a memory of the transmitter and wherein signals received by the receiver are compared in a processing unit of the receiver with search codes stored in a further memory of the receiver and wherein in case of identity of the received signals with the search codes a previously set response signal is released by the receiver, and that the search code consists of a sequence of at least three code words differing from each other and that the individual sequences are separated from each other by a pause interval.

2. The Prior Art

Such a system is known, for instance, from DE 694 18 377 T2. The known system consists of a household appliance and an external apparatus for the parameterization, error diagnosis and remote maintenance of the household appliance. One of the appliance and the apparatus is provided with a transmitter and the other of the appliance and apparatus is provided with a receiver designed for exchanging electromagnetic radiation in the wavelength range of visible light or infra red and actuable by actuation of an actuator on the corresponding appliance or apparatus. When the transmitter is actuated it continuously transmits search codes consisting of a plurality of code words which differ from each other and which were previously set and stored in a memory of the transmitter. In processing unit of the receiver signals received by the receiver are compared with search codes stored in a further memory of the receiver. If the received signals and the search codes are in conformance, a previously set response signal is released by the receiver. The search code consists of a sequence of at least three code words differing from each other, and the individual sequences are separated from each other by a pause interval.

Furthermore, a display control for a display device of a household appliance is known from DE 196 15 358 A1 for the serial and parallel display of data relating to several simultaneously operated household appliances, on the display device. One embodiment provides for wireless data transmission.

### OBJECTS OF THE INVENTION

It is, therefore, an object of the invention to provide a system consisting of a household appliance and an external apparatus in which, without sacrifice of the operating comfort for the user, there is no need for an indicative marking perceptible by the human eye of an interface for a signal and data exchange between the household appliance and the external apparatus and in which the safety of preventing undesired response signals and quick reaction of the receiving unit are improved at the same time.

Other objects will in part be obvious and will in part appear hereinafter.

### BRIEF SUMMARY OF THE INVENTION

In accordance with the invention, this and other objects are accomplished by a system of the kind referred to in which the comparison in the receiver between the received signals and the stored search code is not commenced until at least five successively received code words have been received. Preferably, the response signal is formed as a response code consisting of a single code word which can be transmitted from the receiver to the transmitter. The response signal may be rendered perceptible to human senses by at least one of the appliance and apparatus either as a visible signal on a display or an acoustic signal by a loudspeaker.

Aside from the possibility of avoiding the need for indicative markings perceptible to the human eye of an interface for a signal or data exchange between the household appliance and the external apparatus while at the same time maintaining the handling comfort for an operator, the particular advantages of the invention reside in the fact that the control panel need not be provided with printed markings or the like for indicating the interface between the household appliance and the external apparatus. This results in a simpler control panel which can be more cost-efficiently manufactured. In addition, the optical overall appearance of the control panel is improved and it is possible to design the control panel without consideration of any required indication of the area of the interface of the household appliance,

The search code consists of a sequence of at least three code words differing from each other, and the individual sequences are separated from each other by a pause interval. In this manner it becomes possible safely to prevent the issuance of a response signal because of possible electromagnetic interference signals, for instance from other electric apparatus, and at the same time to ensure a quick reaction of the receiving unit to signals received. The pause interval during which the continuous transmission of the search code is interrupted, the transmission unit which is also structured as a receiver of electromagnetic radiation such as, for example, the response signal, may itself receive and process signals.

Since comparison of the received signals in the receiving unit with the stored search code does not start until after sequential reception of at least five code words, there is improved safety against undesired response signals as well as a rapid reaction by the receiving unit.

In terms of its type and duration the response signal may be selected from a wide variety. Advantageously, the response signal consists of a single response code which may be transmitted from the receiving unit to the transmission unit.

In another advantageous embodiment of the invention the response signal releases and acoustic or optical recognition signal at a loudspeaker or display of at least one of the two devices, which is perceptible to human hearing or vision. In this manner, the user receives a direct and easily recognizable information about the progress of the search.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 as a partially perspective rendition of the system in accordance with the invention, and

FIG. 2 is a partially sectional presentation of details of the system of FIG. 1.

### DETAILED DESCRIPTION OF THE PREFERRED EMBODIMENTS

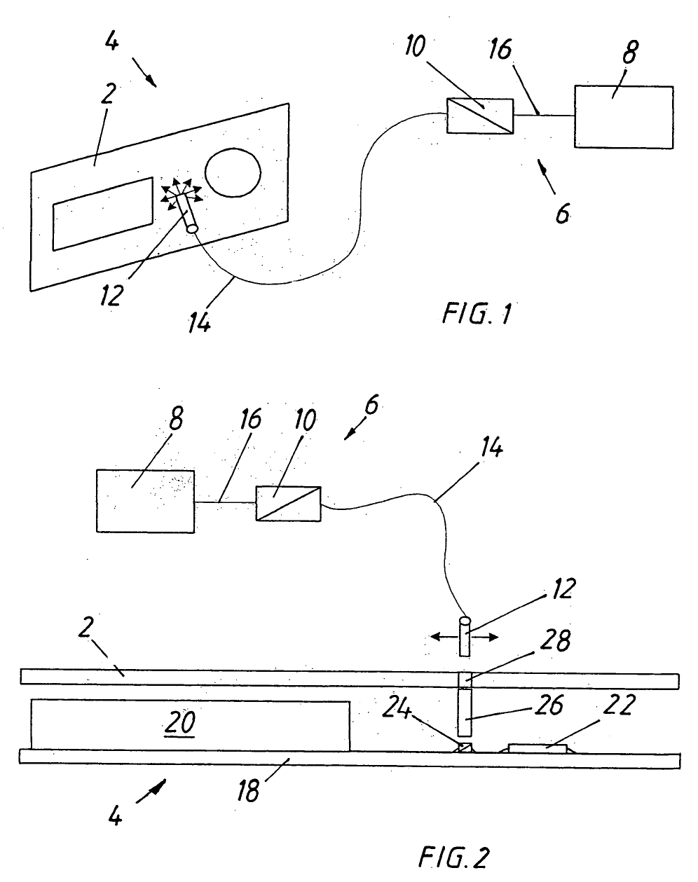

FIG. 1 depicts parts of the system in accordance with the invention in a simplified manner. The system consists of a household appliance 4 which is indicated in FIG. 1 by its control panel 2 only, and of an external apparatus (not shown) for the parameterization, diagnosis of errors and remote maintenance of the household appliance 4. The household appliance and the external apparatus will hereinafter sometimes be collectively referred to as “devices”. In the present case, the external apparatus may, for instance, be a portable customer service computer. The portable customer service computer is provided with a loudspeaker (not shown) for issuing an acoustic recognition signal which is perceptible to human hearing. Alternatively or in addition, the computer may be provided with a visual display for issuing visible recognition signals. In the present embodiment, the external apparatus is provided with a transmitting unit 6, and the household appliance is provided with a receiving unit which is not shown in FIG. 1. The transmitter unit 6 and the receiver unit are capable of exchanging electromagnetic radiation in the infrared range. Persons skilled in the art will appreciate, however, that electromagnetic radiation of other wavelengths such as, for instance, visible light, could be utilized to equal advantage. The transmitter unit 6 and receiver unit may be actuated by an actuator connected to either or both devices. In the present embodiment, the transmitter unit 6 and the receiver unit are structured such that they simultaneously transmit and receive electromagnetic radiation, such as IR radiation. They are thus capable of exchanging signals bidirectionally.

The transmitter unit 6 is provided with a module 8 consisting of a memory (storage) and a processing unit. A previously set search code consisting of at least three code words which differ from each other is stored in the memory 8. In the present embodiment, the search code consists of three code words, presented hexadecimally, for instance, as FO, CC and AA. Moreover, the transmitter unit 6 is equipped with an opto-electrical transducer 10 to which a transmission head 12 may be connected by means of a fiber-optical strand 14. In the present embodiment, the opto-electrical transducer 10 is shown to be connected to the memory 8 by a cable 16 for the transmission of signals. Furthermore, the opto-electrical transducer 10 is provided with a light-emitting diode (LED) (not shown) for the emission of a recognition signal perceptible to the human eye. As an alternative to the present embodiment, it would be possible to unite or integrate the mentioned components of the transmitter unit 6, i.e. the opto-electrical transducer 10, the transmission head 12, the fiber-optical strand 14 and the cable 16 in a common component. The advantage of the present embodiment resides in an improved handling comfort for a user in view of the fact that, as will hereinafter be described in greater detail, he need only hold and move the transmission head 12.

The structure of the receiving unit will be described in greater detail with reference to FIG. 2. A may be seen in FIG. 2, a board 18 is disposed inside the household appliance 4, behind the control panel 2. In addition to other components common in household appliances, such as, for instance a display unit 20, the receiving unit is arranged on the board 18. The receiving unit is provided with a processing unit and a further memory combined to a single component 22, a further opto-electrical transducer 24 and a further fiber optical strand 26. The search code described in greater detail hereinbefore and a prior set response signal are stored in the further memory, the response signal of the present embodiment being formed of a single code word, such as, for example, 00 in hexadecimal presentation. The further fiber optical strand 26 is required in this embodiment for bridging the space between the control panel 2 and the further opto-electrical transducer 24. Alternatively, other embodiments are possible in which no such additional fiber optical strand 26 would be required. To make an exchange of signals possible between the transmission head 12 and the receiving unit, the area 28 of the control panel which is in contact with the further fiber optical strand 26 must be pervious to IR radiation, that is to say of the electromagnetic wave range of the exchanged signals.

The operation of the above-described embodiment of the system in accordance with the invention will be described in greater detail with reference to FIGS. 1 and 2.

The household appliance 4 is switched on so that the receiving unit is active. The customer service representative switches on the portable computer and initiates a search function which activates the transmission unit 6. Once the search function has been started, the transmission unit 6, in manner well-known to persons skilled in the art, continuously transmits the search code stored in the memory of the component 8 into the surroundings. As soon as the customer service representative moves the transmission head close to the area 28 or into the vicinity of the receiving unit arranged behind the control panel 2—in the present embodiment this may be 2 to 4 cm, and the vertical of the surface of the transmission head 12 which transmits the infrared search code is aligned in the direction of the area 28, the search code emitted from the transmission head 12 is received by the receiving unit and is fed to the processing unit arranged in the component 22 by way of the further fiber optical strand 26 and further opto-electrical transducer 24 as is well known to the skilled artisan.

After the receiving unit has sequentially received five code words, the received signals are compared, as is well-known to skilled artisans, by an evaluation circuit of the processing unit of the receiving unit against the search code stored in the further memory. If the received signals are in conformity with the stored search code, which is assumed to be the case in this example, the response signal stored in the further memory is transmitted from the receiving unit to the transmission unit in an analogous manner to the previously mentioned search codes. In the present example, a pause interval is provided between each of the individual sequences of the continuously transmitted search codes. During the pause intervals the continuous transmission of search codes is briefly interrupted. Analogously to the receiving unit, the response signal consisting of a single code word, for instance 00, hexadecimally presented, is compared in the transmission unit 6 against a prior set response signal stored in the memory of the component 8, in a manner well-known to persons skilled in the art. If the signals received by the transmission unit 6 coincide with the stored response signal, the transmission unit 6 will switch on the LED disposed in the opto-electrical transducer 10 and the loudspeaker of the portable customer service computer will issue a prior set audio signal. Alternatively, a simpler circuit design would provide for switching on the LED of the opto-electrical transducer 10 directly by the electrical signals passing from the receiving unit through the opto-electrical transducer 10 in the direction of the transmission unit 6. Thus, the customer service representative will be informed by the illuminated LED as well as by the audio signal that the transmission head 12 is in the area 28 of the control panel 2, so that further signals or data may be exchanged between the household appliance 4 and the portable customer service computer in a manner known to a skilled artisan. As an alternative to the mentioned issuance of an acoustic and/or optical recognition signal from the external apparatus, it would be possible to utilize the display unit 20 of the household appliance for the emission of an optical recognition signal.

If the customer service representative were to move the transmission head 12 away from the area 28 of the control panel 2, the search code transmitted by the transmission head 12, because of the increasing distance between the transmission head 12 and the receiving unit and/or because the vertical of the surface of the transmission head 12 is no longer aligned with the area 28, would no longer provide a signal sufficiently strong for evaluation by the the receiving unit.

1. A system for the parameterization, error analysis and remove maintenance of a household appliance, comprising:
a household appliance;
an external apparatus;
means associated with the appliance and external apparatus for exchanging therebetween electromagnetic radiation in one of the visible light and infrared wavelength ranges by respectively continuously transmitting a first search code in sequences separated by a pause interval and consisting of a plurality of code words differing from each other code and comparing the first search code with a second search code;
means responsive to conformity between the first and second search codes for issuing a response signal after sequentially receiving at least five code words.

2. The system of claim 1, wherein the response signal is a response code consisting of a single code word transmitted from the means responsive to conformity to the exchanging means.

3. The system of claim 2, further comprising means responsive to the response code for issuing at least one of an audio and video signal.

4. The system of claim 1, wherein the means for exchanging the electromagnetic radiation comprises a transponder in each of the household appliance and external apparatus.

5. The system of claim 1, wherein the external apparatus is a customer service computer.

6. The system of claim 5, wherein the answer code is transmitted by an opto-electrical transducer in the household appliance at a predetermined area thereof and wherein the computer comprises means for detecting the area in response to the answer code.

7. The system of claim 1, wherein the first and second search codes are stored in first and second memories.
